(19) United States
(12) Patent Application Publication
(10) Pub. No.: US 2008/0222179 A1
(43) Pub. Date: Sep. 11, 2008

(54) APPARATUS AND METHOD FOR SHARING AND REUSE OF STRUCTURED KNOWLEDGE ARTIFACTS

(75) Inventors: Scott R. GREENE, DEFIANCE, MO (US); James M. MILSTEAD, MADISON, AL (US); Thomas A. RENFERT, MANCHESTER, MO (US); Donna C. BEARDMORE, O'FALLON, MO (US); David M. HESTER, ST. LOUIS, MO (US)

Correspondence Address: BROSEMER, KOLEFAS & ASSOCIATES, LLC - (BOEING), 1 BETHANY ROAD, Suite 58, HAZLET, NJ, 07730, US

(73) Assignee: THE BOEING COMPANY, CHICAGO, IL (US)

(21) Appl. No.: 11/684,623

(22) Filed: Mar. 11, 2007

(51) Int. Cl. G06F 17/40

(52) U.S. Cl. 707/101

(57) ABSTRACT

In areas that require repetitive data collection and entry, an efficient way to reuse data that is already available in the system is proposed. This technique involves the reuse of data artifact fields, validation and categorization of data artifacts, and computerized filling in of “inheritable” data into reports such as aircraft maintenance reports.

### CROSS REFERENCE TO RELATED APPLICATION

This application is related to U.S. application Ser. No. 11/264,490 of Milstead et al., entitled SYSTEM, METHOD AND COMPUTER PROGRAM PRODUCT FOR STRUCTURED DATA CAPTURE, filed Oct. 31, 2005.

### TECHNICAL FIELD

This disclosure relates to data collection and entry. More particularly, this disclosure relates to an efficient way to reuse data that has already been collected so that accurate and consistent reports can efficiently be created and analyzed.

### BACKGROUND

In some work environments, such as aircraft maintenance, many employees work together to accomplish a shared task, such as documenting problems with an aircraft. When the nature of the shared task includes some creative element, the potential exists for a good deal of variation in how employees accomplish the task. In the case of documenting problems, each employee may have his or her own way of describing the defective condition. This results in the creation of many different variations of essentially the same information. This lack of data consistency makes analysis of the data produced by these employees very difficult. Additionally, these data products are typically created repeatedly in the work environment because many aircraft will have the same defects. However, the lack of structure to the data or a means of efficiently sharing and comparing the data renders it nearly useless for re-use or training.

Data artifacts often are reproduced over and over from scratch which wastes time. Much of the data in new artifacts are duplications of data in earlier artifacts. If all of the duplicate information from a previous artifact can be used to produce a new artifact, then the data provider only has to provide the unique information to the new artifact. There is a need for a mechanism for sharing information that is commonly needed (“common problems”), or information that has been erroneously omitted (“escapes”—problems found by one employee that should have been found by another, according to a work process).

Many data artifacts are essentially the same, even though they may be difficult to compare programmatically, for example, two different ad-hoc descriptions of the same defect on an aircraft. These artifacts also constitute important business information (frequently occurring problems, common escapes, technical data on aircraft) and must be secured while in use and in transit.

Many employees who produce repetitive information artifacts have resorted to office productivity tools, such as Microsoft Excel spreadsheets, as a means of keeping track of their “favorite” artifacts which they then reuse. These are not easy to share or reuse. Because they are not sufficiently or consistently structured, it is difficult to control their configuration or to ensure their accuracy over time.

### SUMMARY

A computerized apparatus and method of creating, sharing and/or reusing information artifacts which have been captured according to a template addresses the problems outlined above. In one embodiment of the invention, a system for sharing information artifacts comprises a web server and a knowledge base connected to the web server. The knowledge base contains a library of stored data artifacts. At least one data entry device with user interface and local data storage is used to select, enter, and manage data artifacts stored in the knowledge base.

In another embodiment of the invention, a method for creating data artifacts involves the creation of a template containing a set of data elements pertinent to a report. One or more of the data elements are inheritable from one report to another. Data is entered according to the requirements of the template to create a report. The report may be used as the basis of a new data artifact, where at least one of the data elements associated with the report is inheritable. Additional values for any inheritable data element from the report that is the basis for the new artifact is provided. New data artifacts may be categorized as common, escape, favorite, or other types. A unique name is assigned to the data artifact. The artifact name may be either computer generated or user generated. Once the new artifact has been given a type and name, it may be stored in a knowledge base.

In an additional embodiment of the invention, a method of reusing a data artifact to create a report involves entry of data according to a template that defines data elements needed to complete a data collection process. A computer generated list of artifacts is automatically received from a knowledge base, the list of artifacts matching the data that has been entered at any given point in the data collection process. A user selects one of the artifacts in the list, the selected artifact being relevant to the data being entered into the template. The selected artifact represents at least one inheritable data element. The inheritable data elements in the selected artifact are automatically copied from the selected artifact into the report. The user enters data into remaining data fields of the report which were not inherited from the artifact to meet the template requirements and complete the data collection process.

In some embodiments of the invention, actual human readable reports may be generated based on stored artifacts. For example, aircraft maintenance reports and other business reports may be produced.

The features, functions, and advantages that are discussed herein can be achieved independently in various embodiments of the present invention or may be combined in yet other embodiments further details of which can be seen with reference to the following description and drawings.

### BRIEF DESCRIPTION OF THE DRAWINGS

FIG. 1 is a flow chart of one embodiment of the invention.

FIG. 2 is a diagram of an example of a physical architecture that may be used to implement the embodiment of the invention illustrated in FIG. 1.

FIG. 3 is a screen shot observable on the client data collection computers of FIG. 2 illustrating part of the operation of the embodiment of the invention shown in FIG. 1.

FIG. 4 is a screen shot showing loading of a selected artifact used to create a report and the copying of inheritable data into a current context.

FIG. 5 is a screen shot illustrating management of data artifacts.

FIG. 6 is a screen shot illustrating examples of common artifact properties.

FIG. 7 is a screen shot illustrating values associated with an example of an artifact.

FIG. 8 is a screen shot showing addition of properties to an illustrative artifact.

FIG. 9 is a schematic diagram showing the creation of an illustrative report from a stored data artifact.

FIG. 9A shows illustrative details in XML form of the report shown in FIG. 9.

FIG. 9B shows illustrative details in XML form of the artifact shown in FIG. 9.

FIG. 9C shows illustrative details in XML form of the current report shown in FIG. 9.

FIG. 10 is a human readable report generated by XSL transformation of the XML representation of the report shown in FIG. 9C.

### DETAILED DESCRIPTION

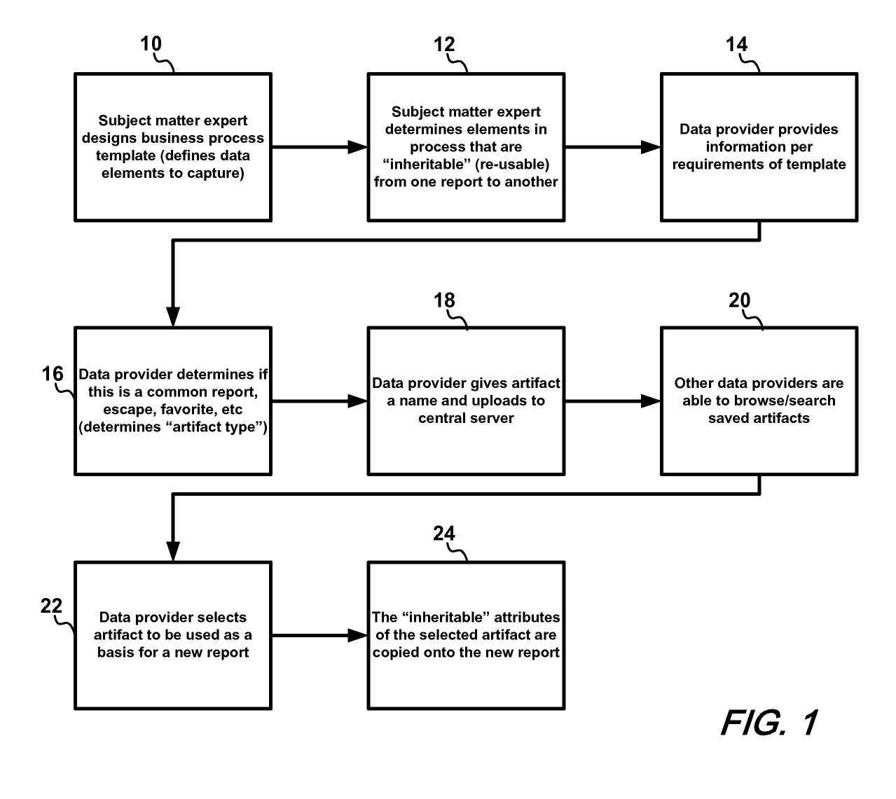

FIG. 1 is a flow chart illustrating the operation of one example of the invention. First, in block 10, a subject matter expert designs a business process template and determines the data elements that need to be captured to implement the process. An example of such a process would be the creation of a report about a maintenance and inspection procedure carried out in the aerospace industry. The data elements to be captured may include items such as aircraft model number, serial numbers, and descriptive information about the condition of certain portions of an aircraft so that repair and maintenance procedures can be performed. Once the operation of block 10 has been completed, the subject matter expert then determines in block 12 the elements of the process that are inheritable or reusable from one report to another. In other words, the subject matter expert determines which elements of the process can be used in more than one report and do not have to re-entered by a user when a report is produced.

The first data provider or collector to use the work of the subject matter expert then provides information in block 14 per the requirements of the template created by the subject matter expert. The first data provider then designates the type of report being created, for example, a common report, an escape, a favorite, or another kind of report. This determines the type of artifact that will be created and stored for later use after the creation of the report. The data provider then provides a name for the artifact in block 18 and uploads the artifact to an artifact library stored in a data base associated with a central server or computer. Other data providers are able to search or browse the artifacts stored in the central server pursuant to block 20. The next data provider or collector then can select the uploaded artifact that may be used as the basis for a new report in block 22. The inheritable attributes of the selected artifact are automatically copied by the computer connected to the library of artifacts into the new report.

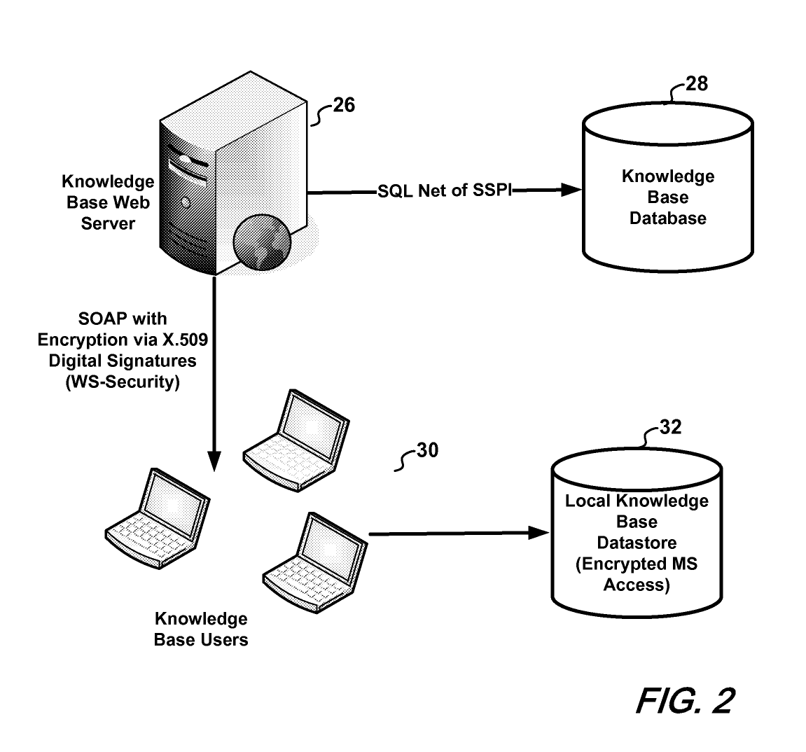

FIG. 2 shows a physical architecture in accordance with one implementation of the invention. The physical architecture includes a central computer 26 which may be a web server communicating with a knowledge data base 28 containing a library of stored data artifacts used to prepare reports in accordance with a business process. The architecture of FIG. 2 also includes one or more client computers 30 that may take the form of personal computers with suitable displays such as lap top computers. The invention, however, is not limited to any particular form of client device. The client computers 30 are connected to a local data base 32 that may take the form of an encrypted Microsoft Access data base. The clients 30 communicate with the central computer 26 by way of any appropriate communication protocol such as the well known Simple Object Access Protocol (SOAP) with encryption via X.509 Digital Signatures (WS-Security). The central computer 26 also communicates with the data base 28 via any appropriate data base access protocol such as SQL Net or SSPI.

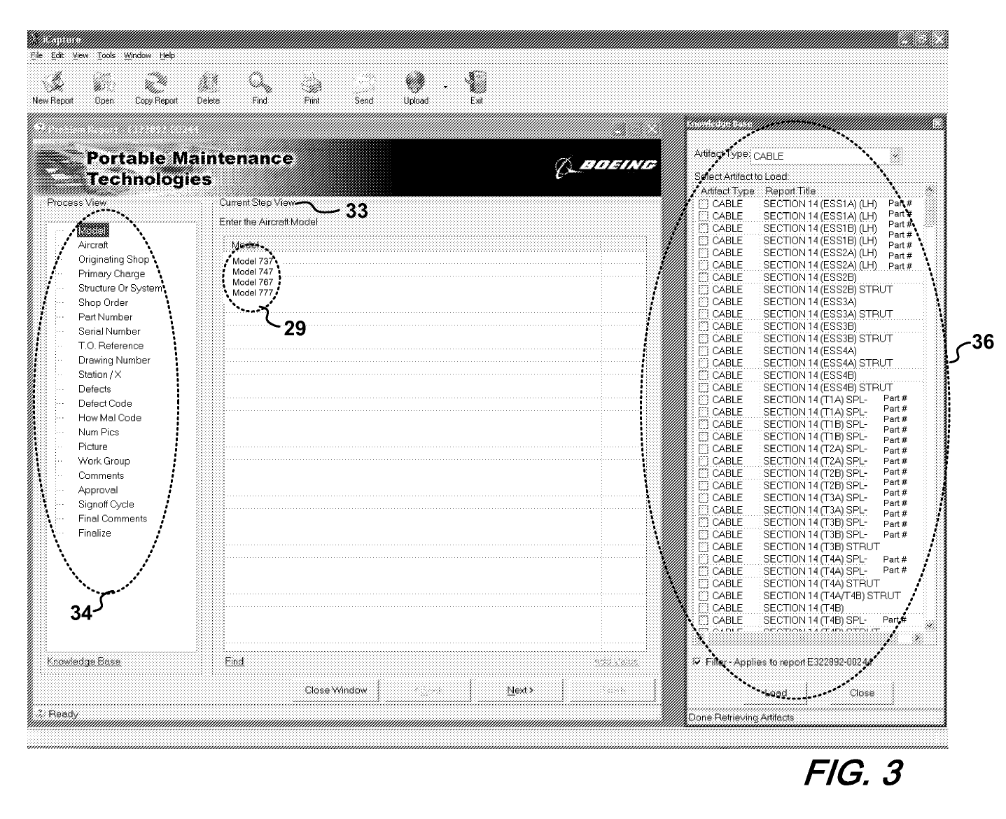

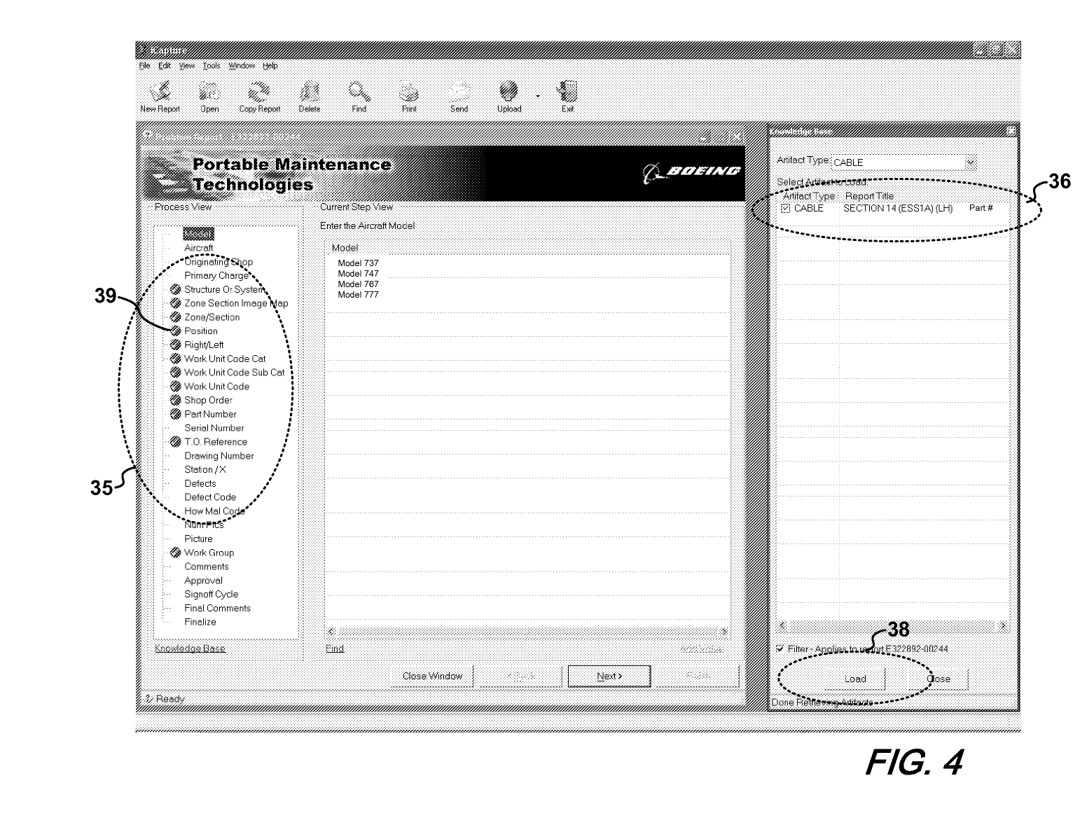

FIGS. 3 and 4 are is screen shots of what is displayed to a user at one of the client computers 30 in FIG. 2 during the process of creating a report in accordance with blocks 20, 22 and 24 in FIG. 1. FIG. 3 shows a template 34 that defines the data articles that must be supplied by the data provider to complete the data collection process. As the user populates the list of data articles in the template 34 in FIG. 3, a context 35 shown in FIG. 4 is created which keeps track of which data elements have been entered. The data base 28 and computer 26 provide a list 36 of stored artifacts that match the values already specified by the data provider in the context 35. For example, when the user specifies the aircraft model by checking one of the model numbers 29 in the Current Step View 33, the computer 26 provides a list 36 of all stored artifacts pertinent to the selected aircraft model number. The data provider is able to select one of the artifacts in the list 36 and load it by activating button 38. When an artifact has been selected and loaded, all of the inheritable properties (values) associated with the selected artifact are automatically copied into the current context 35 as indicated by the checkmarks 39 shown in FIG. 4. These values are automatically entered in appropriate places in the report which saves the user the time it takes to do this manually and avoids potential errors and inconsistencies with earlier reports.

A user may create an artifact by providing data according to a template. A new artifact may also be created from an existing report. The user may specify an existing report to use as the basis of a new data artifact, where at least one of the data elements associated with the report is inheritable. The user then provides additional values for any inheritable data element from the report that is the basis for the new artifact. The data in the template or existing report constitutes an artifact, where some of the data elements can be designated as “inheritable,” that is, usable as elements in a new artifact.

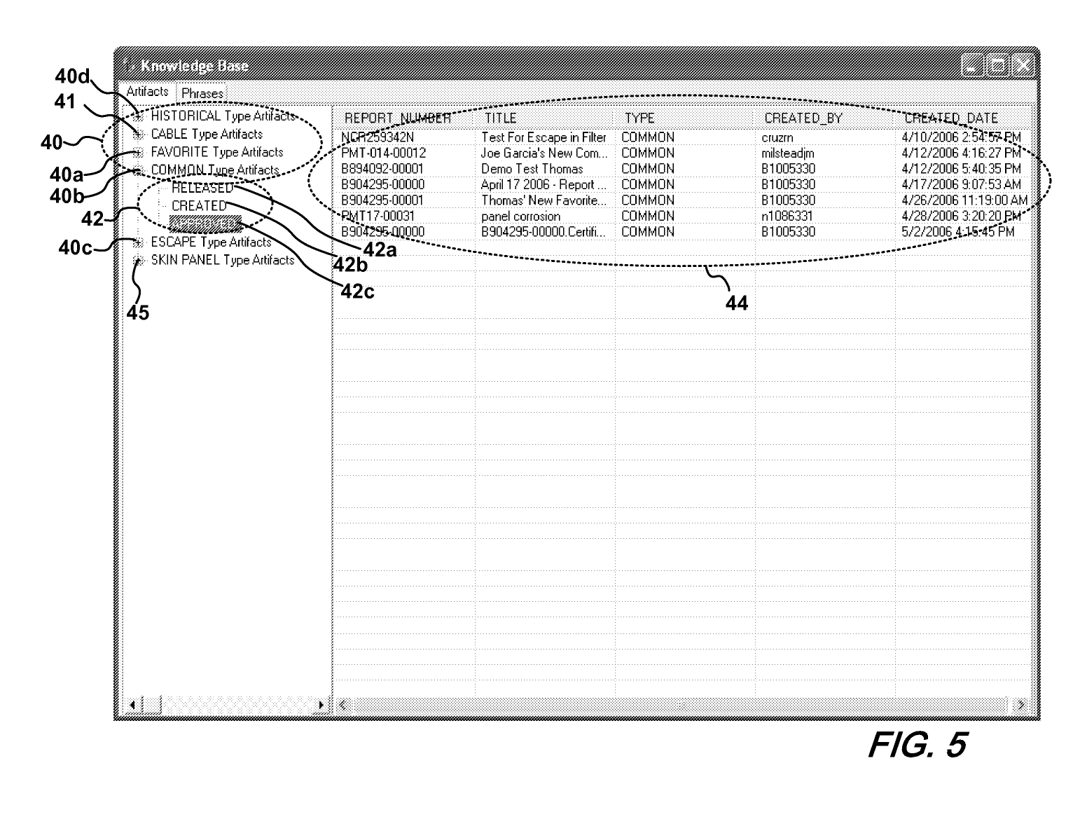

Knowledge base artifacts may be organized and managed by classifying them according to type and/or status within a business organization. This is illustrated by the screen shot shown in FIG. 5 which is displayed on a client computer 30. Artifacts may be given one of the “type” parameters 40 shown in FIG. 5. The “type” parameter of the artifact may be, but is not limited to:

1. Favorite—a user-defined favorite artifact shown at reference numeral 40a in FIG. 5;

2. Common—an artifact that should be shared by more than one user shown at reference numeral 40b in FIG. 5;

3. Escape—an artifact identified by one user, where another user “should” have previously identified the artifact, but did not, shown at reference numeral 40c in FIG. 5; and

4. Historical—default, shown at reference numeral 40d.

Additional types can be added for other user-defined purposes such as the illustrative cable type 41 and skin panel type 45 shown in FIG. 5.

One or more of the artifacts, such as the common artifacts, may also be given a state value such as those shown at 42 in FIG. 5. The state value identifies the status of the artifact within a business organization, such as released 42a, created 42b, and approved 42c in FIG. 5. The displays of the client computers 30 in FIG. 2 are able to display a list of artifacts stored in the data base 26 matching the selected type/state 42c, such as the list 44 of artifacts that are the approved common artifacts.

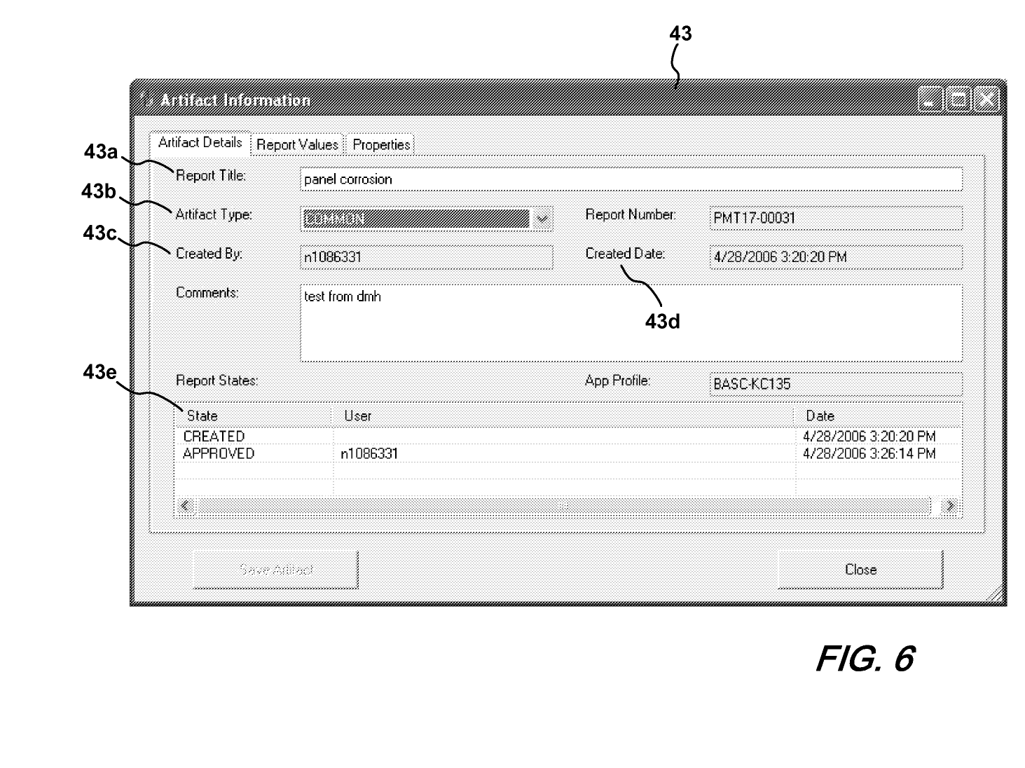

Information about existing stored artifacts can be displayed as shown in FIG. 6. For example, common artifact properties, such as report title 43a, type 43b, author 43c, creation date 43d, and state 43e (approve, released, etc.) of an artifact can be displayed in window 43 on one of the client computers 30.

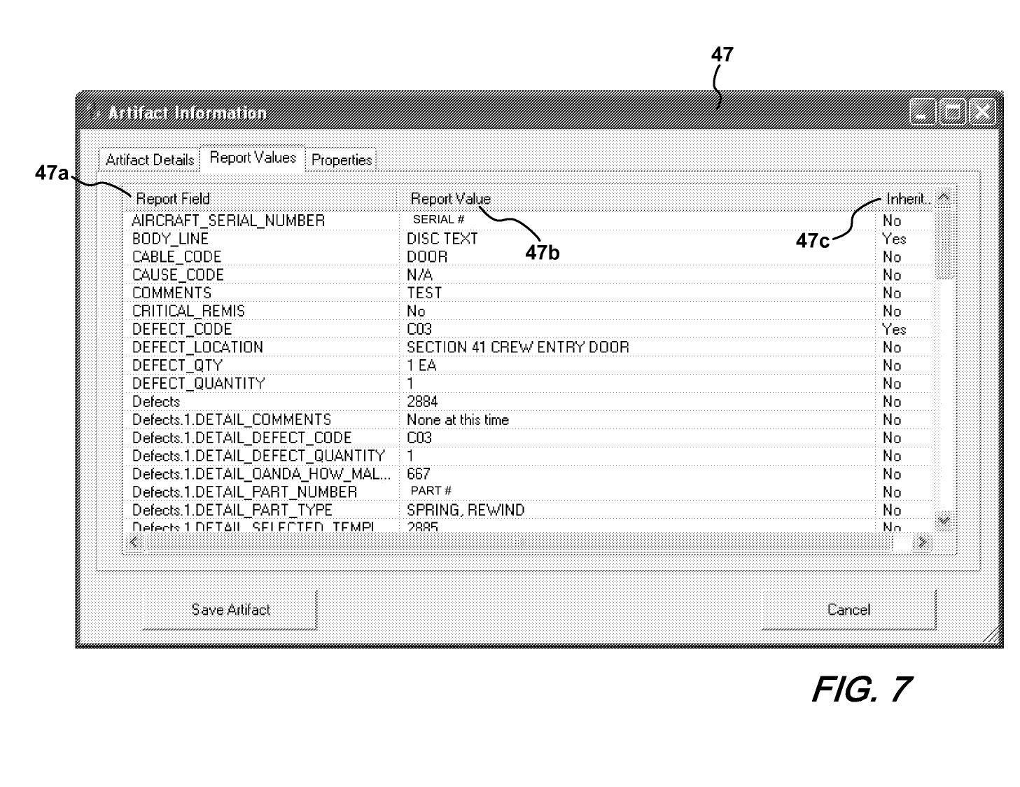

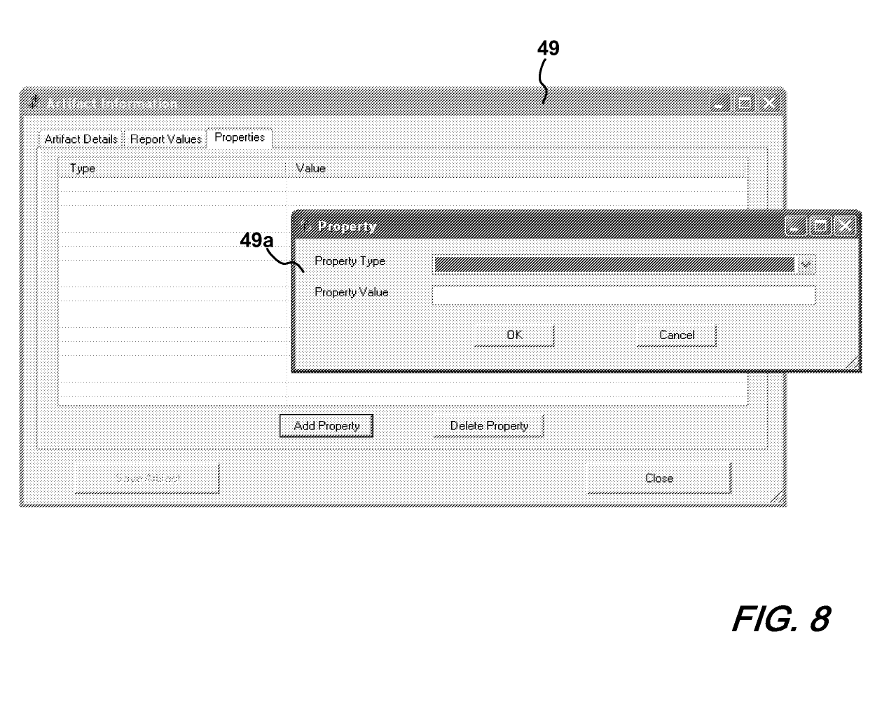

The values associated with an artifact, along with whether or not the value is inheritable can be displayed in window 47 as shown in FIG. 7. Window 47 includes a column of information 47a which is a list of report fields in the artifact being examined. Window 47 also includes a column of information 47b which lists the values in respective report fields in column 47a. Column 47c lists whether or not its associated report value is inheritable. An artifact administrator may add properties, such as program code and location, which can be used to further group, categorize, or identify artifacts, as shown in the screen shots 49 and 49a of FIG. 8.

Once an artifact has been newly created, it may be uploaded to the central computer 26 via any communications protocol, such as the well-known SOAP web service protocol referred to above, where it is compared to all existing artifacts in the data base. The comparison is based on all of the inheritable elements in the uploaded artifact as compared to the inheritable elements in the artifacts already stored in the data base. If there already is an artifact with the same inheritable elements in the data base, the user is alerted via the display of a client computer 30 that such an artifact with the same attributes already exists. The user may then either store the new artifact under its own unique name or the user may discard the new artifact and rely on the previously created duplicate artifact.

When a user chooses to create a new artifact, he may be is presented with a list of all artifacts available in the library of artifacts stored in the data base 28, such as the list 36 shown in FIG. 3. As the user inputs new values to a current artifact, the list of knowledge base artifacts that have inheritable values matching the values he/she has already selected will continue to be shown in the list and those artifacts that do not have inheritable values matching the selected values will be removed from the list. As an example, once a user has selected an aircraft model and a “zone” on the aircraft, the system will be able to query artifacts in the database which match the selected aircraft model and exist in the selected zone. Once a knowledge artifact is selected and loaded, all of the inheritable attributes related to that artifact can be added to the existing user context.

New users can familiarize themselves with the “common” and “escape” artifacts so that they can know what information they will be required to provide repetitively, as well as what information others in their position have failed to provide in the past. These artifacts can then be used as a basis for creating a new information artifact when needed, providing a time savings from creating the artifact from scratch.

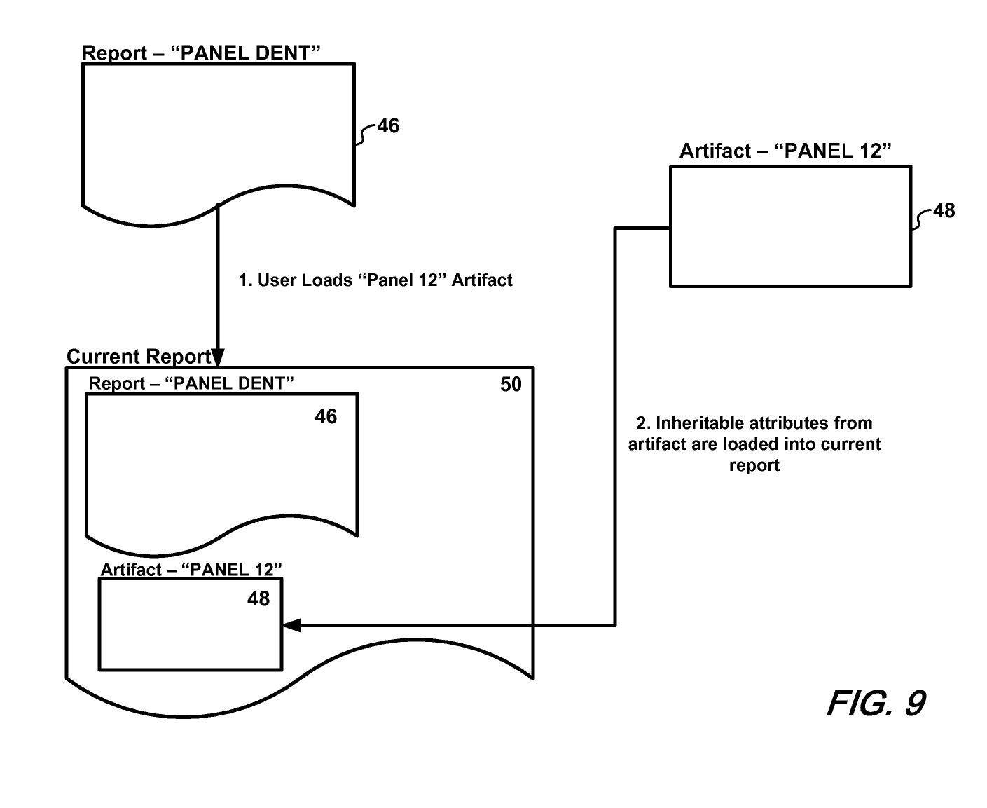

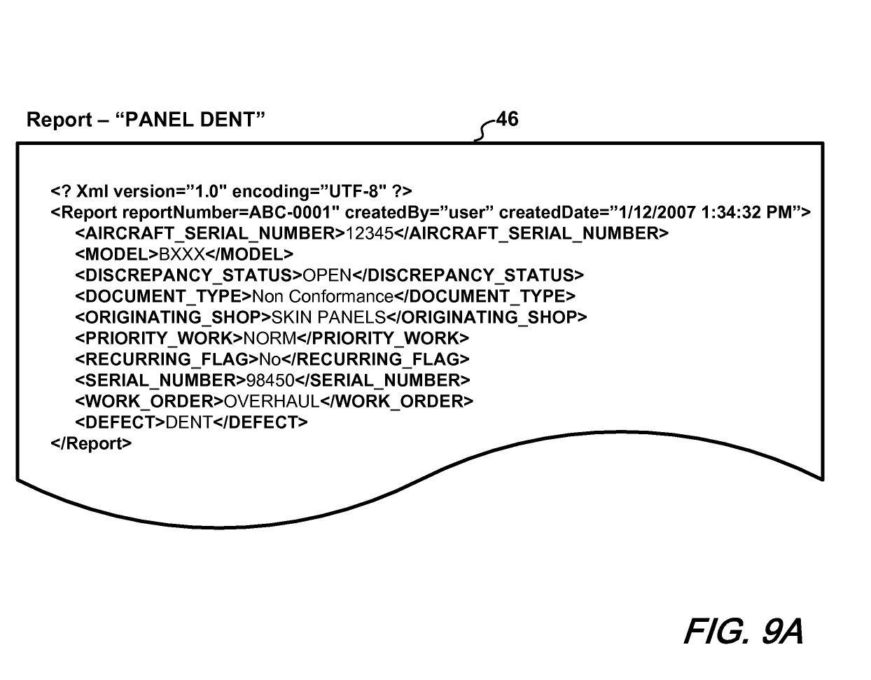

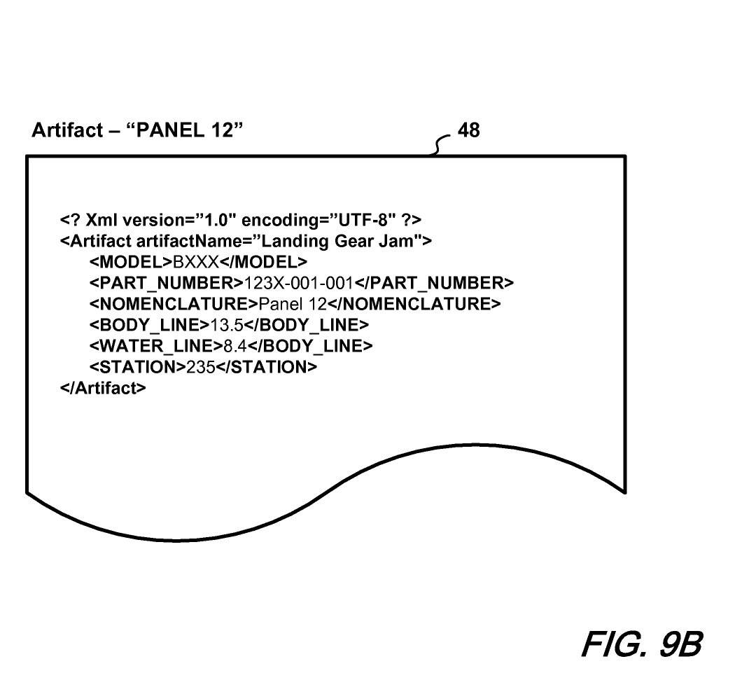

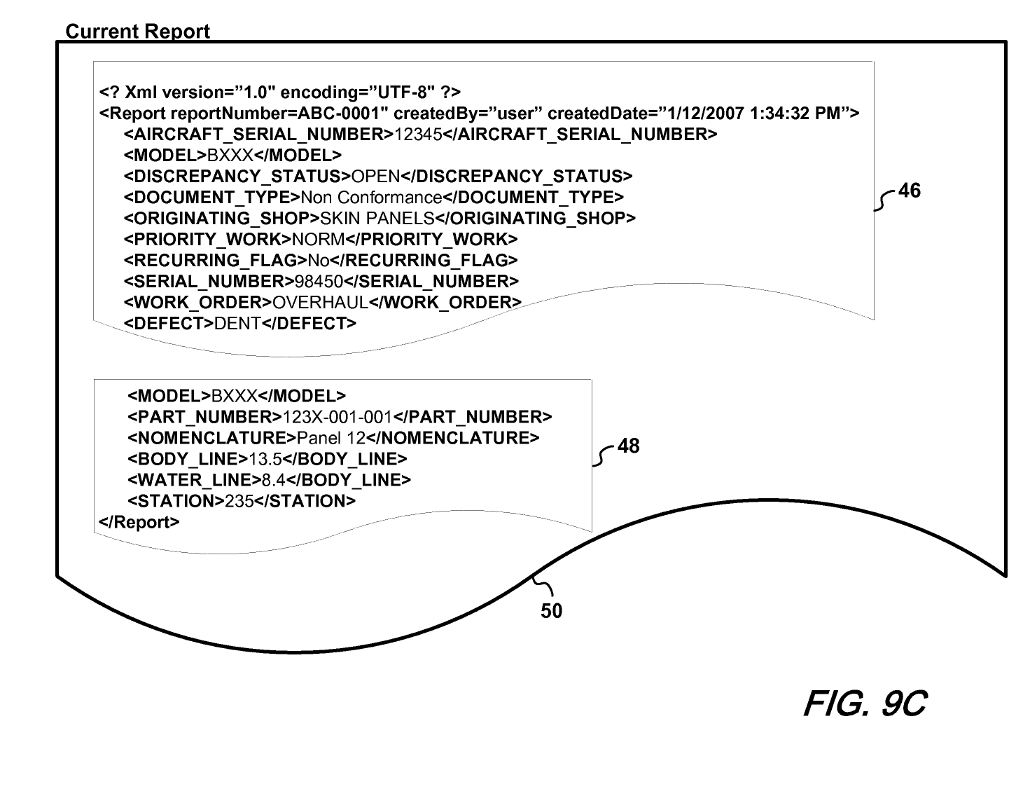

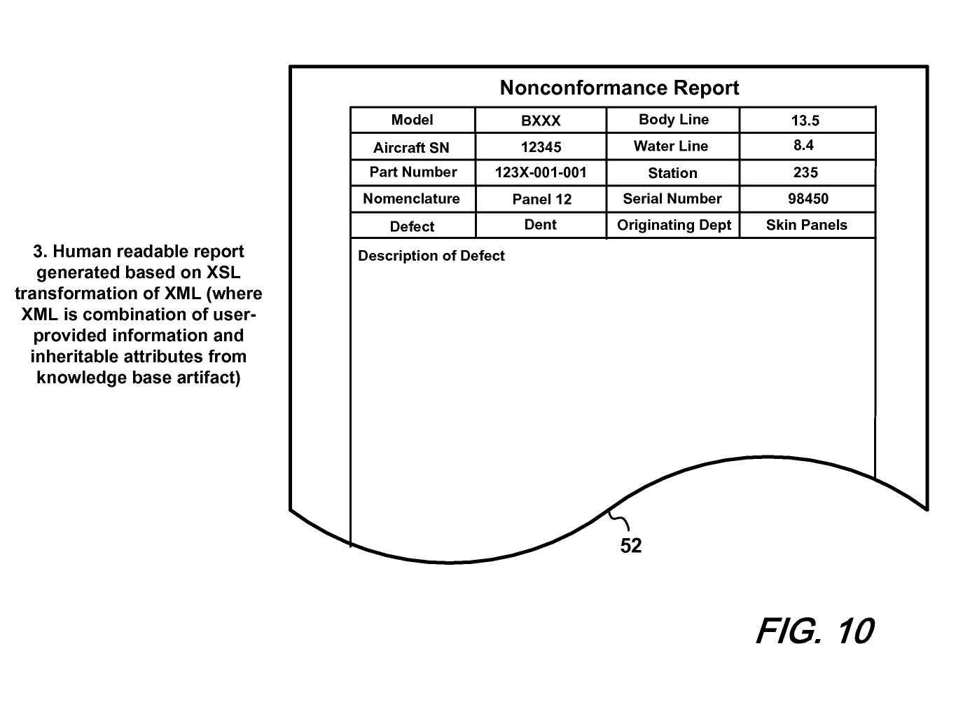

FIG. 9 shows an illustrative XML representation of a data artifact and the creation of a report about the condition of an aircraft panel based on the illustrated artifact. The XML artifact 46 first is loaded into a current report 50 and then the inheritable attributes 48 from the artifact are copied into the report 50. Illustrative details of the XML artifact 46 are shown in FIG. 9A; illustrative details in XML of the inheritable attributes 48 are shown in FIG. 9B. FIG. 9C shows the details of the current report 50. A human readable version 52 of the XML report of FIG. 9 is shown in FIG. 10. The human readable version can be generated by an XSL transformation of XML report, where the XML version of the report is a combination of the user-provided information and inheritable attributes from the artifact stored in the data base 28.

The various embodiments of computerized apparatus and methods described above solve significant problems associated with repetitive data collection operations and report generation. For areas that require repetitive data entry, such as aircraft maintenance, the disclosed apparatus and method ensure data consistency and speed of entry. The apparatus and method reduce the entry of duplicate data already existing in the system that is needed in subsequent reports.

Although the examples of the invention described herein have been shown in the context of creating aircraft maintenance reports, the invention may be used to create any type of report involving repetitive data collection scenarios, for example, appraisals, audits, police reports, FEMA damage assessments, facilities maintenance, health care, power plant operations, and others. Given a template for collecting data from a user, the ability to then reuse and share data collected according to that template would be very useful in all such scenarios.

The Title, Technical Field, Background, Summary, Brief Description of the Drawings, Detailed Description, and Abstract are meant to illustrate the preferred embodiments of the invention and are not in any way intended to limit the scope of the invention. The scope of the invention is solely defined and limited by the claims set forth below.

1. A system for sharing information artifacts stored in a computer knowledge base comprising:
a web server;
a knowledge base connected to the web server and containing a library of stored data artifacts;
at least one data entry device with user interface for selecting, entering and managing data artifacts stored in the knowledge base; and
local data storage connected to the data entry device.

2. The system of claim 1, in which the data entry device is a personal computer.

3. The system of claim 1, in which the user interface is a computer display.

4. The system of claim 1, in which the knowledge base comprises a computer data base containing one or more stored data artifacts.

5. The system of claim 1, in which the one of more data artifacts represent information used to create a report.

6. The system of claim 5, in which the data artifacts comprise at least one inheritable data element that is usable in a plurality of reports.

7. The system of claim 5, in which the report is an aircraft maintenance report.

8. The system of claim 1, in which the web server communicates with the knowledge base via a predetermined data base access protocol.

9. The system of claim 8, in which the predetermined data base access protocol is the SQL Net protocol.

10. The system of claim 8, in which the predetermined data base protocol is the SSPI protocol.

11. The system of claim 1, in which the personal computer communicates with the web server via a predetermined communications protocol.

12. The system of claim 11, in which the predetermined communication protocol is the SOAP protocol.

13. The system of claim 12, the SOAP protocol comprises encryption via X.509 digital signatures.

14. The system of claim 1, in which the local data storage comprises a data base.

15. The system of claim 14, in which the data base is a Microsoft Access data base.

16. The system of claim 14, in which the data storage contains encrypted information.

17. A method of creating data artifacts, comprising the steps of:
creating a template containing a set of data elements pertinent to a report;
designating which one or more of the data elements are inheritable from one report to another;
entering data according to the requirements of the template to create a report;
specifying the report as the basis of a new stored data artifact, where at least one of the data elements associated with the report are inheritable;
providing additional values for any inheritable data element from the report that is the basis for the new artifact;
categorizing the data artifact as one of the group consisting of common, escape, favorite, or user-defined types;
assigning a unique name to the data artifact, where the artifact name is computer generated or user generated; and
storing the new artifact in a computer knowledge base.

18. The method of claim 17, further comprising the step of:
using the new artifact to create a report.

19. A method of using a data artifact stored in a computer knowledge base to create a report, comprising the steps of:
entering data according to a template that defines data elements needed to complete a data collection process;
automatically receiving a computer generated list of artifacts from a knowledge base, the list of artifacts matching the data that has been entered at any given point in the data collection process;
selecting one of the artifacts in the list, the selected artifact being relevant to the data being entered into the template, and the selected artifact comprising at least one inheritable data element;
automatically copying the inheritable data elements from the selected artifact to the report; and
entering additional data into fields defined by the selected artifact not already containing inheritable data elements to meet the template requirements and complete the data collection process.

20. The method of claim 19, in which the inheritable data element is a data element that can be used in more than one report.

21. The method of claim 19, further comprising the step of:
producing the report based on the stored artifact and the entered data.

22. The method of claim 21, in which the report is an aircraft maintenance report.

23. The method of claim 21, in which the step of producing a report comprises the step of:
producing an XML representation of the report.

24. The method of claim 23, in which the step of producing a report comprises the step of:
translating the XML representation of the report into human readable form.

25. The method of claim 24, in which the translating step comprises the step of:
performing an XSL translation of the XML representation of the report.
